(19) United States
(12) Patent Application Publication
(10) Pub. No.: US 2018/0273647 A1
(43) Pub. Date: Sep. 27, 2018

(54) METHOD FOR CONCENTRATING BETA-GLUCANS

(71) Applicant: Wintershall Holding GmbH, Kassel (DE)

(72) Inventors: Sascha ROLLIE, Mannheim (DE); Christoph ZIEGLER, Neustadt (DE); Florian LEHR, Ludwigshafen (DE); Tobias KÄPPLER, Maxdorf (DE); Andrea SEIBERT, Griescheim (DE); Thomas LETZELTER, Annweiler (DE); Andreas WEBER, Mutterstadt (DE); Stephan FREYER, Neustadt (DE); Georg GROSSMANN, Mannheim (DE); Burkhard Ernst, Giesen (DE)

(21) Appl. No.: 15/521,436

(22) PCT Filed: Oct. 30, 2015
(86) PCT No.: PCT/EP2015/075243

§ 371 Date: Apr. 24, 2017

(30) Foreign Application Priority Data
Oct. 31, 2014 (EP) 14191302.0

(51) Int. Cl. C08B 37/00

(52) U.S. Cl. CPC C08B 37/0024; C08B 37/0003

(57) ABSTRACT

The presently claimed invention relates to a method for concentrating a beta-glucan comprising at least the following steps:
(a1) contacting an aqueous beta-glucan solution having a concentration [c1] with at least one precipitating agent p1 to obtain a precipitated beta-glucan in a solvent mixture comprising water and the at least one precipitating agent p1; (b1) separating the precipitated beta-glucan from the solvent mixture comprising water and the at least one precipitating agent p1 to obtain a precipitated beta-glucan having a concentration [c2]; and (c1) applying force to the precipitated beta-glucan of (b1) to obtain a precipitated beta-glucan having a concentration [c3].

The presently claimed invention relates to a method for concentrating a beta-glucan comprising at least the following steps:

(a1) contacting an aqueous beta-glucan solution having a concentration [c1] with at least one precipitating agent p1 to obtain a precipitated beta-glucan in a solvent mixture comprising water and the at least one precipitating agent p1; (b1) separating the precipitated beta-glucan from the solvent mixture comprising water and the at least one precipitating agent p1 to obtain a precipitated beta-glucan having a concentration [c2]; and (c1) applying force to the precipitated beta-glucan of (b1) to obtain a precipitated beta-glucan having a concentration [c3].

Beta-glucans are known well-conserved components of cell walls in several microorganisms, particularly in fungi and yeast (Novak, Endocrine, Metabol & Immune Disorders Drug Targets (2009), 9: 67-75). Biochemically, beta-glucans are non-cellulosic polymers of beta-glucose linked via glycosidic beta(1-3) bonds exhibiting a certain branching pattern with beta(1-6) bound glucose molecules (Novak, lac cit). A large number of closely related beta-glucans exhibit a similar branching pattern such as schizophyllan, scleroglucan, pendulan, cinerian, laminarin, lentinan and pleuran, all of which exhibit a linear main chain of beta-D-(1-3)-glucopyranosyl units with a single beta-D-glucopyranosyl unit (1-6) linked to a beta-D-glucopyranosyl unit of the linear main chain with an average branching degree of about 0.3 (Novak, loc cit; EP-B1 463540; Stahmann, Appl Environ Microbial (1992), 58: 3347-3354; Kim, Biotechnol Letters (2006), 28: 439-446; Nikitina, Food Technol Biotechnol (2007), 45: 230-237). At least two of said beta-glucans—schizophyllan and scleroglucan—even share an identical structure and differ only slightly in their molecular mass, i.e. in their chain length (Survase, Food Technol Biotechnol (2007), 107-118).

Beta-glucans can inter alia be used as thickeners in the field of enhanced oil recovery, in particular in the field of tertiary enhanced oil recovery (EOR; also referred to as tertiary oil recovery, TOR or as improved oil recovery, IOR) (Survase, lac cit).

Suitable thickening polymers for tertiary EOR must meet a number of specific requirements. In addition to sufficient viscosity, the polymers must also be thermally very stable and retain their thickening effect even at high salt concentrations.

An important class of polymers of natural origin for polymer flooding comprises branched homopolysaccharides obtained from glucose, e.g., beta-glucans as described above. Aqueous solutions of such beta-glucans have advantageous physicochemical properties, so that they are particularly suitable for polymer flooding.

Many processes for the preparation of beta-glucans comprise the cultivation and fermentation of microorganisms capable of synthesizing such biopolymers. For example, EP 271 907 A2, EP 504 673 A1 and DE 40 12 238 A1 disclose processes for the preparation, i.e. the preparation is effected by batchwise fermentation of the fungus Schizophyllum commune with stirring and aeration. The culture medium substantially comprises glucose, yeast extract, potassium dihydrogen phosphate, magnesium sulfate and water. EP 271 907 A2 describes a method for separating the polysaccharide, in which the culture suspension is first centrifuged and the polysaccharide is precipitated from the supernatant with isopropanol. A second method comprises a pressure filtration followed by an ultrafiltration of the solution obtained, without details of the method having been disclosed. “Udo Rau, “Biosynthese, Produktion and Eigenschaften von extrazellularen Pilz-Glucanen”, Habilitationsschrift, Technical University of Brunswick, 1997, pages 70 to 95″ and “Udo Rau, Biopolymers, Editor A. Steinbiichel, Volume 6, pages 63 to 79, WILEY-VCH Publishers, New York, 2002” describe the preparation of schizophyllan by continuous or batchwise fermentation. “GIT Fachzeitung Labor 12/92, pages 1233-1238” describes a continuous preparation of branched beta-1,3-glucans with cell recycling. WO 03/016545 A2 discloses a continuous process for the preparation of scleroglucans using Sclerotium rolfsii.

Furthermore, for economic reasons, the concentration of aqueous beta-glucan solutions should be as high as possible in order to minimize efforts of transporting the aqueous glucan solutions from the production site to the place of use. For this purpose, beta-glucan solutions are usually concentrated by drying, lyophilization and/or precipitation before being transported in order to reduce their weight.

However, concentrated beta-glucan solutions having low residual moisture can hardly be redissolved in water and viscosity—which is important for the usage of the solution in EOR—is drastically reduced (Rau, Methods in Biotechnology (1999), 10: 43-55, DOI: 10.1007/978-1-59259-261-6_4; Kumar, Am J Food Technol (2011), 6: 781-789).

A method for the purification of beta-1,3-glucans is also disclosed in EP 0 515 216 A2, comprising contacting with a hot alkaline solution of a microbially produced 1,3-beta-glucan with a mixture of water and an organic solvent to have beta-glucan precipitated in pure form.

DE 601 02 806 T2 discloses a dry biopolymer in solid form comprising particles having a very specifically defined average diameter. According to this document, the very specifically defined particle size gives rise to a biopolymer that is advantageously dispersible in water.

AU 2001235690 B2 discloses the use of particles of biopolymers having a specific particle diameter, for example as thickening or viscosity, emulsifying and/or stabilizing agent in industrial, food, cosmetic and pharmaceutical formulations.

WO 2009/062561 A1 discloses a process for the preparation of purified beta-(1,3)-D-glucans

US 2012/270033 A1 describes a method for coating a sheet-like cellulose containing material by applying a composition comprising schizophyllan and at least one solvent on the surface of the sheet-like material.

U.S. Pat. No. 4,950,749 describes a process for the recovery of nonionic glucans by adding a divalent cation to a solution containing solubilized glucan and then adjusting the solution to an alkaline pH resulting in the precipitation of glucan.

Therefore, the object of the presently claimed invention is to provide an economic method for obtaining beta-glucan in a highly concentrated form that can be re-dissolved in water to obtain an aqueous solution containing beta-glucan.

Thus, the presently claimed invention relates in one aspect to a method for concentrating beta-glucan comprising at least the steps of:

(a1) contacting an aqueous beta-glucan solution having a concentration [c1] of at least 2 g beta-glucan per liter of aqueous solution with at least one precipitating agent p1 to obtain a precipitated beta-glucan in a solvent mixture comprising water and the at least one precipitating agent p1;

(b1) separating the precipitated beta-glucan from the solvent mixture comprising water and the at least one precipitating agent p1 obtained in step (a1) to obtain a precipitated beta-glucan having a concentration [c2];

(c1) applying force to the precipitated beta-glucan obtained in step (b1) to obtain a precipitated beta-glucan having a concentration [c3] of 50 to 800 g beta-glucan per liter of precipitate comprising the beta-glucan, the water and the at least one precipating agent p1, whereby the order of the concentrations is [c1]<[c2]<[c3].

Thus, the presently claimed invention relates in one aspect to a method for concentrating beta-glucan comprising at least the steps of:

(a1) contacting an aqueous beta-glucan solution having a concentration [c1] of at least 2 g beta-glucan per liter of aqueous solution with at least one precipitating agent p1 at a temperature in the range of 0 to 80° C., more preferably at a temperature in the range of 10 to 70° C., even more preferably at a temperature in the range of 10 to 50° C. and most preferably at a temperature in the range of 10 to 40° C., to obtain a precipitated beta-glucan in a solvent mixture comprising water and the at least one precipitating agent p1;

(b1) separating the precipitated beta-glucan from the solvent mixture comprising water and the at least one precipitating agent p1 obtained in step (a1) to obtain a precipitated beta-glucan having a concentration [c2];

(c1) applying force to the precipitated beta-glucan obtained in step (b1) to obtain a precipitated beta-glucan having a concentration [c3] of 50 to 800 g beta-glucan per liter of precipitate comprising the beta-glucan, the water and the at least one precipating agent p1,

whereby the order of the concentrations is [c1]<[c2]<[c3].

Surprisingly, it was found that beta-glucan in highly concentrated form that was obtained according to the inventively claimed method can be re-dissolved in water. Generally, in context with the present invention, an aqueous beta-glucan solution is considered to contain beta-glucan that was re-dissolved if no precipitate or solid can be seen anymore after centrifugation of the solution once, twice or thrice at 10.000×g for 2 min, preferably once or twice at 10.000×g for 2 min.

### FIGURES

FIG. 1 Sectional representation of a compression-permeability cell

FIG. 2 Sectional representation of a sieve beaker centrifuge

FIG. 3 Sectional representation of a sieve beaker

The single steps of the method according to the presently claimed invention and details concerning the presently claimed invention will be explained in detail in the following.

Generally, in context with the presently claimed invention, the beta-glucan to be concentrated as described herein may be any beta-glucan. In one embodiment, the beta-glucan is a polymer consisting of a linear main chain of beta-D-(1-3)-glucopyranosyl units having a single beta-D-glucopyranosyl unit (1-6) linked to a beta-D-glucopyranosyl unit of the linear main chain with an average branching degree of about 0.3. In context with the presently claimed invention, the term “average branching degree about 0.3” may mean that in average about 3 of 10 beta-D-(1-3)glucopyranosyl units are (1-6) linked to a single beta-D-glucopyranosyl unit. In this context, the term “about” may mean that the average branching degree may be within the range from 0.25 to 0.35, preferably from 0.25 to 0.33, more preferably from 0.27 to 0.33, most preferably from 0.3 to 0.33. It may also be 0.3 or 0.33. Schizophyllan, scleroglucan, paramylon, pachyman, cellulose, chitin, curdlan, laminarin, chrysolaminarin, lentinan, lichenin, pleuran and zymosan all have an average branching degree between 0.25 and 0.33 (Novak, loc cit, Survase, loc cit); for example, scleroglucan and schizophyllan have an average branching degree of 0.3 to 0.33. The average branching degree of a beta-glucan can be determined by methods known in the art, e.g., by periodic oxidation analysis, methylated sugar analysis and NMR (Brigand, Industrial Gums, Academic Press, New York/USA (1993), 461-472).

In the context of the presently claimed invention, the beta-glucan to be concentrated as described herein is selected from the group consisting of schizophyllan, scleroglucan, paramylon, pachyman, cellulose, chitin, curdlan, laminarin, chrysolaminarin, lentinan, lichenin, pleuran and zymosan. For example, the beta-glucan may be schizophyllan or scleroglucan, particularly schizophyllan.

Generally, in context with the presently claimed invention, the beta-glucan to be concentrated as described herein may be any beta-glucan that is present in the form of one of its derivatives. Beta-glucans can be derivatised, i.e. the chemical structure of the beta-glucan is altered as compared to its naturally occurring state. A beta-glucan in the form of its derivative preferably contains a chemical moiety selected from the group consisting of sulfate, amine, acetate, phosphate, phosphonate and carboxymethyl. Beta-glucans which are present in the form of their carboxymethylated derivatives are inter alia described in U.S. Pat. No. 6,342,486. The disclosure of U.S. Pat. No. 6,342,486 is hereby incorporated by reference.

The presently claimed invention relates to a method for concentrating schizophyllan comprising at least the steps of:

(a1) contacting an aqueous schizophyllan solution having a concentration [c1] of at least 2 g schizophyllan per liter of aqueous solution with at least one precipitating agent p1 to obtain a precipitated schizophyllan in a solvent mixture comprising water and the at least one precipitating agent p1;

(b1) separating the precipitated schizophyllan from the solvent mixture comprising water and the at least one precipitating agent p1 obtained in step (a1) to obtain a precipitated schizophyllan having a concentration [c2];

(c1) applying force to the precipitated schizophyllan obtained in step (b1) to obtain a precipitated schizophyllan having a concentration [c3] of 50 to 800 g schizophyllan per liter of precipitate comprising the schizophyllan, the water and the at least one precipating agent p1, whereby the order of the concentrations is [c1]<[c2]<[c3].

Steps (b1) and (c1) are carried out simultaneously or steps (b1) and (c1) are carried out sequentially, i.e. step (b1) is carried out before step (c1).

In case steps WO and (c1) are carried out simultaneously, [c2] is not measured. However, if the inventively claimed method was terminated before a final concentration [c3] had been reached, a concentration [c2] would be measured that was within the range of [c2] as described herein.

Step (a1);

Step (a1) of the method according to the presently claimed invention comprises contacting an aqueous beta-glucan solution having a concentration [c1] with at least one precipitating agent p1 to obtain a precipitated beta-glucan in a solvent mixture comprising water and the at least one precipitating agent p1.

The aqueous solution that is used in step (a1) of the method according to the presently claimed invention comprises beta-glucan at a concentration [c1]. In general, the concentration [c1] is selected by the skilled artisan or will be predetermined by the source of beta-glucan used according to the presently claimed invention. In general, the aqueous solution that is used in step (a1) of the method according to the presently claimed invention will be taken from the permeate or from the broth of a fermentation process.

In one embodiment of the presently claimed invention, the aqueous beta-glucan solution that is introduced into step (a1) of the method according to the presently claimed invention is filtrated, centrifuged or otherwise treated beforehand, in order to at least partially or completely remove any cells, cell debris and/or other cellular components which accumulated during fermentation of microorganisms producing the beta-glucan.

In another embodiment of the presently claimed invention, the aqueous beta-glucan solution that is introduced into step (a1) is identical to the fermentation broth.

The concentration [c1] according to the presently claimed invention is at least 2 g beta-glucan per liter of aqueous solution that is introduced into step (a1), preferably 2 to 50 g beta-glucan per liter of aqueous solution, more preferably 5 to 40 g beta-glucan per liter of aqueous solution, even more preferably 10 to 40 g beta-glucan per liter of aqueous solution.

According to the presently claimed invention, further components that are present in the aqueous solution that is introduced into step (a1) of the method according to the presently claimed invention are selected from impurities, side products of the method of preparing beta-glucan, salts, acids, bases, surfactants and mixtures thereof.

Step (a1) of the method according to the presently claimed invention is generally conducted at any suitable temperature at which the aqueous solution and the further components involved in step (a1) can be processed, preferably at 0 to 80° C., more preferably at 10 to 70° C., most preferably at 10 to 50° C. and in particular 10 to 40° C.

Step (a1) of the process according to the presently claimed invention is preferably conducted at atmospheric pressure.

According to step (a1) of the method according to the presently claimed invention, at least one precipitating agent p1 is added.

According to the presently claimed invention, in general any agent may be used as precipitating agent p1 as long as it causes precipitation of the beta-glucan that is present in the aqueous solution.

Preferably, the at least one precipitating solution p1 is selected from the group consisting of low boiling liquids, high boiling liquids and mixtures thereof.

Examples of low boiling liquids are formates like methyl formate, acyclic ethers like dimethoxymethane, cyclic ethers like tetrahydrofuran, 2-methyl-1,2-dioxalane, carboxylic acid esters like acetic acid ethyl ester, alcohols like methanol, ethanol, isopropanol or propanol, ketones like acetone or methylethylketone, or mixtures of at least two of them.

Examples of high boiling liquids are polyethylene glycols having molecular weights preferably in the range of 10 to 200 kD, more preferably in the range of 15 to 120 kD, polypropylene glycols having molecular weights in the range of 5 to 100 kD, more preferably 10 to 30 kD, or mixtures of at least two of them.

The at least one precipitating agent p1 is generally added to the aqueous beta-glucan solution in step (a1), so that the volume ratio of the precipating agent p1 to the aqueous solution is in the range of preferably 0.1:1 to 20:1, more preferably 0.2:1 to 2:1, most preferably 0.2:1 to 1.5:1, in each case based on the total mixture that is obtained.

In order to afford effective precipitation of the beta-glucan the aqueous solution of beta-glucan needs intense contact to the at least one precipitating agent p1 which can be achieved by using a stirred vessel, a rotor-stator mixer, a three-way nozzle or any comparable system. Preferably the aqueous solution of beta-glucan is contacted with the at least one precipitating agent p1 in a three-way nozzle. The nozzle contains a first inlet for introducing the aqueous solution of beta-glucan and a second inlet for introducing the precipitating agent p1. The precipitation of beta-glucan takes places in the mixing zone of the three-way nozzle, whereby an amorphous solid is obtained, and a mixture of the precipitating agent p1, water and the precipitated beta-glucan is discharged through an outlet.

After contacting the aqueous solution of beta-glucan with at least one precipitating agent p1, the beta-glucan precipitates, and a two phase mixture comprising a solvent mixture comprising water and the at least one precipitating agent p1 and precipitated beta-glucan is obtained. This mixture is then preferably transferred to step (b1) of the method according to the presently claimed invention.

Step (b1):

Step (b1) of the process according to the presently claimed invention comprises separating the precipitated beta-glucan from the solvent mixture comprising water and the at least one precipitating agent p1 to obtain a precipitated beta-glucan having a concentration [c2].

Step (b1) of the method according to the presently claimed invention can in general be conducted by any methods known to the skilled artisan, for example, inter alia, centrifugation, sedimentation, flotation and filtration.

Preferably, step (b1) of the method according to the presently claimed invention is conducted using a filter press, for example a membrane filter press such as an automatic membrane filter press or a compression-permeability cell, or a filter centrifuge, for example an inverting filter centrifuge.

After step (b1) of the method according to the presently claimed invention, a precipitated beta-glucan is obtained having a concentration [c2].

The concentration [c2] according to the presently claimed invention is preferably 10 to 150 g beta-glucan per liter of precipitate comprising the beta-glucan, the water and the at least one precipating agent p1, more preferably 30 to 120 g beta-glucan per liter of precipitate comprising the beta-glucan, the water and the at least one precipating agent p1, most preferably 40 to 80 g beta-glucan per liter of precipitate comprising the beta-glucan, the water and the at least one precipating agent p1.

Step (b1) of the method according to the presently claimed invention is generally conducted at any suitable temperature at which the precipitated beta-glucan can be separated from the solvent mixture comprising water and the at least one precipitating agent p1, preferably at 0 to 80° C., more preferably at 10 to 70° C., most preferably at 10 to 50° C. and in particular 10 to 40° C.

Step (c1):

Step (c1) of the method according to the presently claimed invention comprises applying force to the beta-glucan of (b1) to obtain a precipitated beta-glucan having a concentration [c3].

Step (c1) of the method according to the presently claimed invention is conducted to remove further aqueous solution from the precipitated beta-glucan to obtain a precipitated beta-glucan having a higher concentration [c3].

In general, in step (c1) of the method according to the presently claimed invention, can preferably be conducted by any method as long as a force in the form of pressure in the range of 3 bar to 25 bar, more preferably in the range of 4 bar to 15 bar, is applied to the precipitated beta-glucan obtained from step (b1).

Preferably, step (c1) of the method according to the presently claimed invention is conducted using a filter press, for example a membrane filter press such as an automatic membrane filter press or a compression-permeability cell, or a filter centrifuge, for example an inverting filter centrifuge.

The filter press can contain a unit for feeding, with a pump, the solvent mixture comprising water, at least one precipitating agent p1 and precipitated beta-glucan obtained in step (a1) under pressure into the device in which a filter plate and a filter cloth are superimposed to forcibly filter the aqueous solution. Alternatively, the precipitated beta-glucan obtained in step (a1) is directly fed into the device such as a filter press or a filter centrifuge such as an inverting filter centrifuge by using the three-way nozzle as injector.

In case a filter press is used to carry out the inventively claimed method, steps (b1) and (c1) are carried out sequentially in the filter press and preferably a force in the form of pressure in the range of 3 bar to 25 bar, more preferably in the range of 4 bar to 15 bar, is used in step (c1).

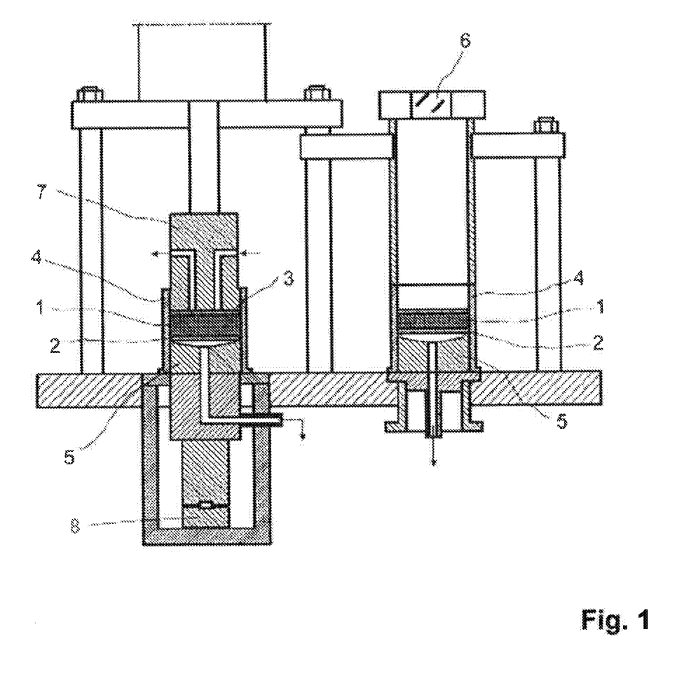

In a preferred embodiment of the presently claimed invention, a compression-permeability cell as depicted in FIG. 1 is used. The compression-permeability cell as depicted in FIG. 1 shows a filter cake (1), a filter medium (2), a distributor plate (3), a ring (4), a filtrate drain (5), a cap (6), a press piston (7) and a load cell (8).

In another embodiment of the presently claimed invention, step (c1) of the presently claimed invention is preferably conducted using a filter centrifuge such as an inverting filter centrifuge. Inverting filter centrifuges can be obtained from Heinkel Process Technology GmbH, Besigheim, Germany and inter alia described in “Heinkel® Stillpzentrifuge HF, 001A/2003-2, DE 195 29 256 A1, De 41 17 323 A1, DE 37 29 240 A1, DE 697 00 957 T2). Preferably the force that is used to carry out step (c1) is in the form of acceleration in the range of 50 to 2000×g, more preferably in the range of 60 to 1500×g, even more preferably in the range of 70 to 1500×g.

An inverting filter centrifuge operates in general without a base layer. Generally speaking, then, a defined amount of beta-glucan obtained in step (a1) or (b1) is introduced into the centrifuge drum, the filtrate is spun off, and the resulting beta-glucan having a concentration [c3] can optionally be dried. For example, the precipitated beta-glucan having a concentration [c3] can be desorbed and dried by passing warm gas such as nitrogen or steam through it.

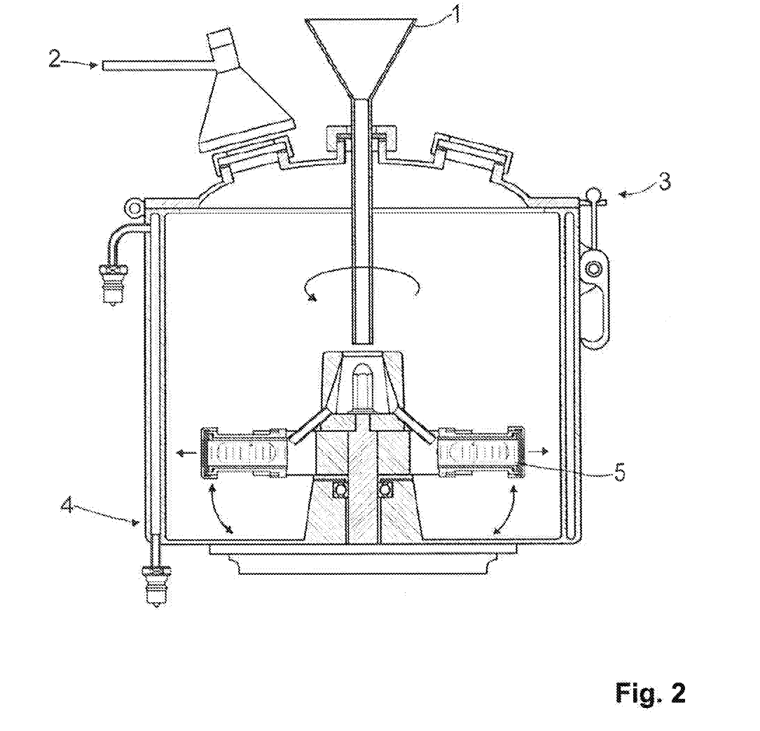

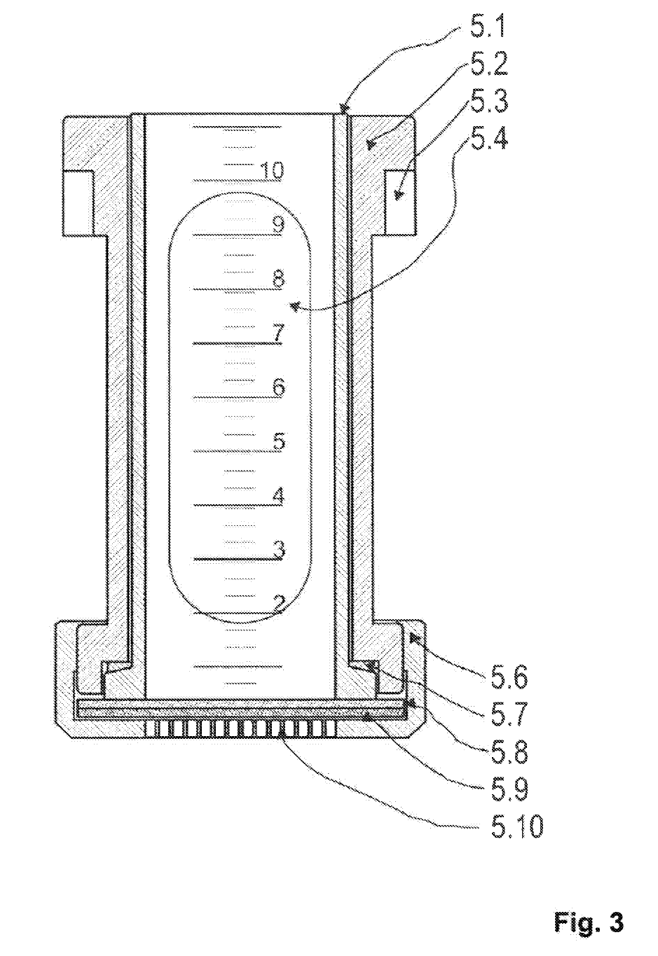

In a preferred embodiment of the presently claimed invention, a sieve beaker centrifuge as depicted in FIG. 2 is used as an inverting filter centrifuge. The sieve beaker centrifuge as depicted in FIG. 2 shows a means for filling (1), a stroboscope (2), a means for rotation (3), a filtrate outlet (4) and a beaker (5). The construction of the beaker is shown in more detail in FIG. 3. The beaker comprises a glass inlet (5.1), a sieve beaker housing (5.2), a mounting notch (5.3), a screw cap (5.6), a gasket ring (5.7), a gasket (5.8), a filter cloth (5.9) and a perforated bottom (5.10). The filling level is indicated as well (5.4).

In case a filter centrifuge such as an inverting filter centrifuge is used for the inventively claimed method, steps (131) and (c1) are carried out simultaneously or sequentially. In case steps (b1) and (c1) are carried out sequentially in a filter centrifuge, the force in form of acceleration is gradually increased so that, in a first step, the water and the at least one precipitating agent is partially removed to arrive at a concentration [c2] and, in a second step, the precipitated beta-glucan is concentrated to the desired concentration [c3]. In case steps (131) and (c1) are carried out simultaneously in a filter centrifuge, the force in form of acceleration is adjusted to value that ensures removing the water and the precipitating agent p1 while at the same time concentrating the precipitated beta-glucan to the desired concentration [c3]. In this case [c2] is not measured. However, if the inventively claimed method was terminated before a final concentration [c3] had been reached, a concentration [c2] would be measured that was within the range of [c2] as described herein.

Step (c1) of the method according to the presently claimed invention is generally conducted at any suitable temperature at which the force can be applied to a precipitated glucan, preferably at 0 to 80° C., more preferably at 10 to 70° C., most preferably at 10 to 50° C. and in particular 10 to 40° C.

After step (c1) of the process according to the presently claimed invention, a precipitated beta-glucan is obtained having a concentration [c3].

Concentration [c3] according to the presently claimed invention is 50 to 800 g beta-glucan per liter of precipitate comprising the beta-glucan, the water and the at least one precipating agent p1, preferably 50 to 600 g beta-glucan per liter of precipitate comprising the beta-glucan, the water and the at least one precipating agent p1, and more preferably 50 to 570 g beta-glucan per liter of precipitate comprising the beta-glucan, the water and the at least one precipating agent p1.

With the method according to the presently claimed invention, it is therefore possible to obtain a precipitated beta-glucan with a concentration of preferably 50 to 800 g/l. This high concentration gives rise to the advantage that the transport to the places of application is facilitated, because a highly concentrated beta-glucan can be transported without large amounts of water. At the place of application, the highly concentrated beta-glucan can then be redissolved in water to obtain a solution/dispersion ready for use.

Preferably, the presently claimed invention relates to a method for concentrating schizophyllan comprising at least the steps of:

(a1) contacting an aqueous schizophyllan solution having a concentration [c1] of at least 2 g schizophyllan per liter of aqueous solution with at least one precipitating agent p1 to obtain a precipitated schizophyllan in a solvent mixture comprising water and the at least one precipitating agent p1;

(b1) separating the precipitated schizophyllan from the a solvent mixture comprising water and the at least one precipitating agent p1 obtained in step (a1) to obtain a precipitated schizophyllan having a concentration [c2];

(c1) applying force to the precipitated schizophyllan obtained in step (b1) to obtain a precipitated schizophyllan having a concentration [c3] of 50 to 800 g schizophyllan per liter of precipitate comprising the schizophyllan, the water and the at least one precipating agent p1, whereby the order of the concentrations is [c1]<[c2]<[c3].

Preferably, the presently claimed invention relates to a method for concentrating schizophyllan comprising at least the steps of:

(a1) contacting an aqueous schizophyllan solution having a concentration [c1] of at least 2 g schizophyllan per liter of aqueous solution with at least one precipitating agent p1 at a temperature in the range of 0 to 80° C., more preferably at a temperature in the range of 10 to 70° C., even more preferably at a temperature in the range of 10 to 50° C. and most preferably at a temperature in the range of 10 to 40° C., in a stirred vessel, in a rotor-stator mixer or in a three-way nozzle, to obtain a precipitated schizophyllan in a solvent mixture comprising water and the at least one precipitating agent p1;

(b1) separating the precipitated schizophyllan from the a solvent mixture comprising water and the at least one precipitating agent p1 obtained in step (a1) to obtain a precipitated schizophyllan having a concentration [c2];

(c1) applying force to the precipitated schizophyllan obtained in step (b1) to obtain a precipitated schizophyllan having a concentration [c3] of 50 to 800 g schizophyllan per liter of precipitate comprising the schizophyllan, the water and the at least one precipating agent p1, whereby the order of the concentrations is [c1]<[c2]<[c3].

More preferably, the presently claimed invention relates to a method for concentrating schizophyllan comprising at least the steps of:

(a1) contacting an aqueous schizophyllan solution having a concentration [c1] of at least 2 g schizophyllan per liter of aqueous solution with at least one precipitating agent p1 to obtain a precipitated schizophyllan in a solvent mixture comprising water and the at least one precipitating agent p1;

(b1) separating the precipitated schizophyllan from the solvent mixture comprising water and the at least one precipitating agent p1 obtained in step (a1) to obtain a precipitated schizophyllan having a concentration [c2];

(c1) applying force to the precipitated schizophyllan obtained in step (b1) to obtain a precipitated schizophyllan having a concentration [c3] of 50 to 800 g schizophyllan per liter of precipitate comprising the schizophyllan, the water and the at least one precipating agent p1, whereby the order of the concentrations is [c1]<[c2]<[c3] and steps (b1) and (c1) are carried out sequentially in a filter press.

More preferably, the presently claimed invention relates to a method for concentrating schizophyllan comprising at least the steps of:

(a1) contacting an aqueous schizophyllan solution having a concentration [c1] of at least 2 g schizophyllan per liter of aqueous solution with at least one precipitating agent p1 to obtain a precipitated schizophyllan in a solvent mixture comprising water and the at least one precipitating agent p1;

(b1) separating the precipitated schizophyllan from the solvent mixture comprising water and the at least one precipitating agent p1 obtained in step (a1) to obtain a precipitated schizophyllan having a concentration [c2];

(c1) applying force to the precipitated schizophyllan obtained in step (b1) to obtain a precipitated schizophyllan having a concentration [c3] of 50 to 800 g schizophyllan per liter of precipitate comprising the schizophyllan, the water and the at least one precipating agent p1, whereby the order of the concentrations is [c1]<[c2]<[c3] and steps (b1) and (c1) are simultaneously carried out in a filter centrifuge such as an inverting filter centrifuge or are sequentially carried out in a filter centrifuge such as an inverting filter centrifuge.

More preferably, the presently claimed invention relates to a method for concentrating schizophyllan comprising at least the steps of:

(a1) contacting an aqueous schizophyllan solution having a concentration [c1] of at least 2 g schizophyllan per liter of aqueous solution with at least one precipitating agent p1 to obtain a precipitated schizophyllan in a solvent mixture comprising water and the at least one precipitating agent p1;

(b1) separating the precipitated schizophyllan from the solvent mixture comprising water and the at least one precipitating agent p1 obtained in step (a1) to obtain a precipitated schizophyllan having a concentration [c2];

(c1) applying force to the precipitated schizophyllan obtained in step (b1) to obtain a precipitated schizophyllan having a concentration [c3] of 50 to 800 g schizophyllan per liter of precipitate comprising the schizophyllan, the water and the at least one precipating agent p1, whereby the order of the concentrations is [c1]<[c2]<[c3] and steps (b1) and (c1) are simultaneously carried out in a filter centrifuge or are sequentially carried out in a filter centrifuge or are carried out sequentially in a filter press.

Even more preferably, the presently claimed invention relates to a method for concentrating schizophyllan comprising at least the steps of:

(a1) contacting an aqueous schizophyllan solution having a concentration [c1] of at least 2 g schizophyllan per liter of aqueous solution with at least one precipitating agent p1 at a temperature in the range of 0 to 80° C., more preferably at a temperature in the range of 10 to 70° C., even more preferably at a temperature in the range of 10 to 50° C. and most preferably at a temperature in the range of 10 to 40° C., in a stirred vessel, in a rotor-stator mixer or in a three-way nozzle, to obtain a precipitated schizophyllan in a solvent mixture comprising water and the at least one precipitating agent p1;

(b1) separating the precipitated schizophyllan from the solvent mixture comprising water and the at least one precipitating agent p1 obtained in step (a1) to obtain a precipitated schizophyllan having a concentration [c2];

(c1) applying force to the precipitated schizophyllan obtained in step (b1) to obtain a precipitated schizophyllan having a concentration [c3] of 50 to 800 g schizophyllan per liter of precipitate comprising the schizophyllan, the water and the at least one precipating agent p1, whereby the order of the concentrations is [c1]<[c2]<[c3] and steps (b1) and (c1) are simultaneously carried out in a filter centrifuge or are sequentially carried out in a filter centrifuge or are carried out sequentially in a filter press.

According to a preferred embodiment of the method according to the presently claimed invention, the presently claimed invention relates to the method as mentioned above comprising steps (a1), (LA) and (c1) and further comprising the following steps (a2) and (b2) that are conducted after step (b1):

(a1) contacting an aqueous beta-glucan solution having a concentration [c1] of at least 2 g beta-glucan per liter of aqueous solution with at least one precipitating agent p1 to obtain a precipitated beta-glucan in a solvent mixture comprising water and the at least one precipitating agent p1;

(b1) separating the precipitated beta-glucan from the solvent mixture comprising water and the at least one precipitating agent p1 obtained in step (a1) to obtain a precipitated beta-glucan;

(a2) contacting the precipitated beta-glucan obtained in step (b1) with at least one precipitating agent p2 to obtain a precipitated beta-glucan in a solvent mixture comprising the water, the at least one precipitating agent p1 and the at least one precipitating agent p2;

(b2) separating the precipitated beta-glucan from the mixture of step (a2) to obtain a precipitated beta-glucan having a concentration [c22];

(c1) applying force to the precipitated beta-glucan obtained in step (b2) to obtain a beta-glucan having a concentration [c3] of 50 to 800 g beta-glucan per liter of precipitate comprising the beta-glucan, the water, the at least one precipating agent p1 and the at least one precipitating agent p2, whereby the order of the concentrations is [d]<[c22]<[c3].

Steps (a1), (b1) and (c1) of this preferred embodiment of the presently claimed invention have been described above. Additional steps (a2) and (b2) will be explained in the following.

Step (a2):

Step (a2) of the process according to the presently claimed invention comprises contacting the precipitated beta-glucan having a concentration [c2] of step (b1) with at least one precipitating agent p2 to obtain a mixture comprising precipitated beta-glucan.

According to a preferred embodiment of the process according to the presently claimed invention, the precipitated beta-glucan of step (b1) is not treated in any way before being introduced into step (a2) of the method according to the presently claimed invention.

Step (a2) of the method according to the present invention is in general conducted at any suitable temperature at which the precipitated beta-glucan of step (b1) and the further components involved in step (a2) can be processed, preferably at a temperature in the range of 0 to 80° C., more preferably at a temperature in the range of 10 to 70° C., even more preferably at a temperature in the range of 10 to 50° C. and most preferably at a temperature in the range of 10 to 40° C.

Step (a2) of the process according to the presently claimed invention is preferably conducted at atmospheric pressure.

According to step (a2) of the method according to the presently claimed invention, at least one precipitating agent p2 is added.

According to the presently claimed invention, in general any agent may be used as precipitating agent p2 as long as it causes precipitation of the beta-glucan present in the solvent mixture comprising the water and at least one precipating agent p1.

According to one embodiment of the presently claimed invention the at least one precipitating agent p2 that is used in step (a2) of the method according to the presently claimed invention is identical to the at least one precipitating agent p1 that has been used in step (a1) of the method according to the presently claimed invention.

Therefore, the presently claimed invention preferably relates to the method according to the presently claimed invention, wherein precipitating agents p1 and p2 are identical.

According to a further embodiment of the presently claimed invention the at least one precipitating agent p2 that is used in step (a2) of the method according to the presently claimed invention is not identical to the at least one precipitating agent p1 that has been used in step (a1) of the method according to the presently claimed invention, but different.

Therefore, the presently claimed invention further preferably relates to the method according to the presently claimed invention, wherein precipitating agents p1 and p2 are not identical, but different.

Preferably, the at least one precipitating solution p2 is selected from the group consisting of low boiling liquids, high boiling liquids and mixtures thereof.

Examples of low boiling liquids are formats like methyl formate, acyclic ethers like dimethoxymethane, cyclic ethers like tetrahydrofuran, 2-methyl-1,2-dioxalane, carboxylic acid esters like acetic acid ethyl ester, alcohols like methanol, ethanol, isopropanol or propanol, ketones like acetone or methylethylketone, or mixtures of at least two of them.

Examples of high boiling liquids are polyethylene glycols having molecular weights of preferably in the range of 10 to 200 kD, more preferably in the range of 15 to 120 kD, polypropylene glycols having molecular weights in the range of 5 to 100 kD, more preferably 10 to 30 kD, or mixtures of at least two of them.

The at least one precipitating agent p2 is in general added to the precipitated glucan obtained in step (b1) comprising water and at least one precipating agent p1 in step (a2), so that the volume ratio of the precipating agent p2 to the precipitated glucan obtained in step (b1) comprising the water and at least one precipating agent p1 is in the range of preferably 0.1:1 to 20:1, more preferably 0.2:1 to 2:1, most preferably 0.2:1 to 1.5:1, in each case based on the total mixture that is obtained.

Upon contacting precipitated glucan obtained in step (b1) comprising the water and at least one precipating agent p1 with at least one precipitating agent p2, the beta-glucan is further concentrated, and a two phase mixture comprising water, the at least one precipitating agent p1 and the at least one precipitating agent p2 and precipitated beta-glucan is obtained. This mixture is then preferably transferred to step (b2) of the method according to the presently claimed invention.

Step (b2):

Step (b2) comprises separating the precipitated beta-glucan from the mixture of step (a2) to obtain beta-glucan having a concentration [c22].

Step (b2) of the method according to the presently claimed invention can in general be conducted by any methods known to the skilled artisan, for example, inter alia, centrifugation, sedimentation and filtration.

The presently claimed invention therefore preferably relates to the methods as mentioned above, wherein step (b2) is conducted by centrifugation, sedimentation and filtration.

Preferably, step (b2) of the method according to the presently claimed invention is conducted using a filter press, for example a membrane filter press such as an automatic membrane filter press or a compression-permeability cell, or a filter centrifuge, for example an inverting filter centrifuge.

After step (b2) of the method according to the presently claimed invention, a precipitated beta-glucan is obtained having a concentration [c22]. In general, concentration [c22] is higher than concentration [c2] as mentioned above.

Step (b2) of the method according to the presently claimed invention is generally conducted at any suitable temperature at which the precipitated beta-glucan can be separated from the solvent mixture, preferably at 0 to 80° C., more preferably at 10 to 70° C., most preferably at 10 to 50° C. and in particular 10 to 40° C.

Concentration [c22] according to the presently claimed invention is preferably 10 to 250 g beta-glucan per liter of precipitate comprising the beta-glucan, the water, the at least one precipating agent p1 and the at least one precipitating agent p2, more preferably 50 to 250 g beta-glucan per liter of precipitate comprising the beta-glucan, the water, the at least one precipating agent p1 and the at least one precipitating agent p2, particularly preferably 60 to 180 g beta-glucan per liter of precipitate comprising the beta-glucan, the water, the at least one precipating agent p1 and the at least one precipitating agent p2.

According to this preferred embodiment, step (c2) is conducted with precipitated beta-glucan obtained in step (b2) and a precipitated beta-glucan is obtained having the desired high beta-glucan concentration [c3].

Step (c2) of the method according to the presently claimed invention is generally conducted at any suitable temperature at which the force can be applied to a precipitated glucan, preferably at 0 to 80° C., more preferably at 10 to 70° C., most preferably at 10 to 50° C. and in particular 10 to 40° C.

With the method according to the presently claimed invention comprising steps (a1), (b1) and (c1) or further comprising steps (a2) and (b2), a beta-glucan can be obtained at a remarkably high concentration [c3] which is advantageous for transporting this product to the places of application.

Thus, in another embodiment the presently claimed invention is directed to a precipitated beta-glucan obtained according to the method described above. In particular, in another embodiment the presently claimed invention is directed to a beta-glucan having a concentration of 50 to 800 g beta-glucan per liter of precipitate comprising the beta-glucan, the water and the at least one precipating agent p1, preferably 50 to 600 g beta-glucan per liter of precipitate comprising the beta-glucan, the water and the at least one precipating agent p1, more preferably 80 to 250 g beta-glucan per liter of precipitate comprising the beta-glucan, the water and the at least one precipating agent p1, which is obtained according to the method described above.

Thus, in another embodiment the presently claimed invention is directed to schizophyllan obtained according to the method described above. In particular, in another embodiment the presently claimed invention is directed to schizophyllan having a concentration of 50 to 800 g schizophyllan per liter of precipitate comprising the schizophyllan, the water and the at least one precipating agent p1, preferably 50 to 600 g schizophyllan per liter of precipitate comprising the schizophyllan, the water and the at least one precipating agent p1, more preferably 80 to 250 g schizophyllan per liter of precipitate comprising the schizophyllan, the water and the at least one precipating agent p1, which is obtained according to the method described above

The inventively claimed beta-glucan such as schizophyllan may be further modified after concentration. The inventively claimed beta-glucan such as schizophyllan may be converted by oxidation, enzyme conversion, acid hydrolysis, heat and/or acid dextrinization or shear. The inventively claimed beta-glucan such as schizophyllan can also be chemically, enzymatically or physically modified. Suitable chemical derivatives of schizophyllan include esters, such as the acetate and half esters, such as the succinate, octenyl succinate and tetradecenyl succinate, phosphate derivatives, ethers such as hydroxyalkyl ethers and cationic ethers, or any other derivatives or combinations thereof. Modification may also be chemical crosslinking. Crosslinking agents that are suitable for use herein include phosphorus oxychloride, epichlorohydrin, sodium trimetaphosphate and adipic acid/acetic acid mixed anhydrides.

The beta-glucan which is prepared according to the inventively claimed method can be redissolved in water.

A step of swelling or steeping of the precipitated beta-glucan of the presently claimed invention before re-dissolving may improve efficacy of re-dissolving and, more importantly, increases the resulting viscosity. However, swelling or steeping of the precipitated beta-glucan is not necessary in order to effect re-dissolution.

In accordance with the method described and provided herein, after concentration and, if applicable, after swelling or steeping, the precipitated beta-glucan is re-dissolved in water. In this context, the water may be high-purity/ultrapure water (also referred to as “aqua purificata” or “aqua purified” according to European Pharmacopoeia (PhEur) or US Pharmacopeia (USP)). The amount of water used for re-dissolving in context with the method described and provided herein may be an amount sufficient to reach the volume of the precipitated beta-glucan solution before precipitation. Generally, in context with the present invention, a beta-glucan solution is considered to contain beta-glucan that was re-dissolved if no precipitate or solid can be seen anymore after centrifugation of the solution at 10,000×g for 2 min.

### EXAMPLES

Schizophyllan was prepared by fermentation from Schizophyllum commune and subsequent separation of the biomass by crossflow filtration.

General Method

Determination of Beta-Glucan Content

1. Weighing of a small amount of the press cake containing beta-glucan, water and a solvent

2. Dilute with demineralized water

3. Shake vigorously by hand to obtain schizophyllan sample

4. Disperse schizophyllan sample briefly using the Ultraturrax

5. Prepare analysis sample containing water, glucanase mixture and schizophyllan sample

6. Prepare blank sample containing schizophyllan sample

7. Incubate analysis sample for 2 to 24 h at 40° C.

8. Filter analysis and blank sample through a syringe filter and analyze the glucose content by means of HPLC 9. Calculate the glucan concentration from difference between residual glucose and glucose after enzyme treatment minus the water of hydrolysis

Precipitation Step

An aqueous solution containing schizophyllan with a concentration of 11 to 12 g/l was prepared. The schizophyllan solution was conveyed by means of pumps from a feed tank to a mixing nozzle and mixed with solvents at a temperature in the range of 20 to 25° C. The nozzle had an inlet diameter for the solvent of 0.7 mm. The inlet diameter for the schizophyllan solution was 1.5 mm. The outlet diameter of the nozzle was 3 mm. Schizophyllan precipitated as an amorphous precipitate. The suspension was filled into a suitable container and passed to solid/liquid separation and analysis.

The following examples were carried out according to the general procedure described above.

### Example 1a and 1b

Precipitation using pure acetone.

Acetone mass flow rate 20 kg/h

Schizophyllan solution mass flow rate 20 kg/h

### Example 2

Precipitation using acetone/ethanol mixture

Acetone mass flow rate 18 kg/h.

Ethanol mass flow rate 2 kg/h.

Schizophyllan mass flow rate 20 kg/h,

### Example 3

Precipitation using acetone/ethanol mixture

Acetone mass flow rate 18 kg/h.

Ethanol mass flow rate 2 kg/h.

Schizophyllan mass flow rate 20 kg/h.

### Example 4

Precipitation using acetone

Acetone mass flow rate 40 kg/h.

Schizophyllan mass flow rate 4 kg/h.

### Example 5

Precipitation using acetone

Acetone mass flow rate 40 kg/h.

Schizophyllan mass flow rate 2 kg/h,

### Example 6

Precipitation using acetone/ethanol mixture

Acetone mass flow rate 18 kg/h.

Ethanol mass flow rate 2 kg/h.

Schizophyllan mass flow rate 20 kg/h.

### Example 7

Precipitation using acetone/ethanol mixture

Acetone mass flow rate 18 kg/h.

Ethanol mass flow rate 2 kg/h.

Schizophyllan mass flow rate 20 kg/h.

Separation of Water and Concentration of Beta-Glucan

A compression-permeability cell manufactured from a hollow steel tube s depicted in FIG. 1 was used at a temperature in the range of 20 to 25° C. The tube was closed at the top by a moveable piston equipped with a filter cloth and contained additional filter cloth [Clear Edge® 25130 F PP, obtainable from Clear Edge Filtration, Geldern, Germany with an air permeability of 4 L/(dm² min)] at the bottom. Different volumes of aqueous suspensions containing precipitated beta-glucan were introduced.

The pressure in the filter press was increased by automatic descent of the press piston. The pressure increase was achieved stepwise (1 bar/min). The outflow of the filtrate was done either via a lower filter cloth and a filtrate line or an upper and a lower filter cloth and filtrate lines. When the final pressure was reached, pressing was still continued for an hour.

TABLE 1
Overview of experimental results in compression-permeability cell

| | Ex. 1a | Ex. 1b | Ex. 2 | Ex. 3 | Ex. 4 | Ex. 5 |
|---|---|---|---|---|---|---|
| ratio of beta- | 1:1 | 1:1 | 1:1 | 1:1 | 1:10 | 1:20 |
| glucan solution | | | | | | |
| to solvent | | | | | | |
| solvent | acetone | acetone | acetone/ | acetone/ | acetone | acetone |
| | | | ethanol | ethanol | | |
| | | | 9:1 | 9:1 | | |
| overall mass of | 938 | 896 | 1615 | 1626 | 719 | 730 |
| aqueous | | | | | | |
| suspension [g] | | | | | | |
| pressure [10⁵ Pa] | — | 3 | — | 3 | — | — |
| second solvent | — | acetone | — | acetone | — | — |
| pressure [10⁵ Pa] | 9 | 9 | 9 | 9 | 9 | 9 |
| mass of beta- | 81.8 | 44.3 | 77.1 | 51.9 | 1.8 | 1.0 |
| glucan filter | | | | | | |
| cake after | | | | | | |
| concentration [g] | | | | | | |
| Glucan content | 67 | 141 | 87 | 185 | 520 | 556 |
| [g/l] | | | | | | |

Alternatively, a sieve beaker centrifuge as depicted in FIG. 2 was used at a temperature in the range of 20 to 25° C.

TABLE 2

| | Ex. 6 | Ex. 7 |
|---|---|---|
| ratio of beta-glucan solution | 1:1 | 1:1 |
| to solvent | | |
| Solvent | acetone/ethanol 9:1 | acetone/ethanol 9:1 |
| intermediate spinning [xg] | — | 101 |
| second solvent | — | acetone |
| final spinning [xg] | 827 | 827 |
| Glucan content [g/l] | 51 | 61 |

Overview of experimental results in sieve beaker centrifuge

Re-Dissolution

The concentrated beta-glucan was manually comminuted, i.e. torn into small strips. For the re-dissolving, the material was placed in a 100 ml beaker and topped up in stages, with stirring, to the original 40 g in order to restore the starting concentration of glucan. The entire sample was then transferred to two conical centrifuge tubes and dispersed for 2 min using Ultraturrax (3800 rpm; T25 digital Ultra-Turrax from IKA). To check whether the entire solid had redissolved, the sample was centrifuged for 2 min at 8500 rpm (10.000×g). Non-dissolved solids collect at the bottom and become visible. If this second phase was observed during the centrifugation, the mixture was ultraturraxed again for 2 min at 3800 rpm. The sample was interpreted as being re-dissolved when no precipitate was formed after the last centrifugation step. This was examined visually.

After re-dissolution the solution containing beta-glucan according to examples 1a, 1b, 2, 3, 4, 5, 6 and 7 was clear.

1. A method for concentrating a beta-glucan comprising the steps of:
(a1) contacting an aqueous beta-glucan solution having a concentration [c1] of at least 2 g beta-glucan per liter of aqueous solution with at least one precipitating agent p1 to obtain a precipitated beta-glucan in an aqueous solvent mixture;
(b1) concentrating by partial separation of the precipitated beta-glucan from the aqueous solvent mixture obtained in step (a1) to obtain a concentrated precipitate beta-glucan having a concentration [c2];
(c1) applying force to the concentrated precipitate beta-glucan obtained in step (b1) to obtain a precipitated beta-glucan having a concentration [c3] of 50 to 800 g beta-glucan per liter of (c1 precipitate, the (c1) precipitate comprising the beta-glucan, the water and the at least one precipating agent p1,
whereby the order of the concentrations is [c1]<[c2]<[c3].

2. The method according to claim 1, wherein the step (a1) is carried out at a temperature in the range of 0 to 80° C.

3. The method according to claim 2, wherein step (a1) is carried out in a mixing apparatus selected from a stirred vessel, a rotor-stator mixer, or a three-way nozzle.

4. The method according to claim 1, wherein steps (b1) and (c1) are carried out simultaneously or sequentially.

5. The method according to claim 1, wherein the concentration [c1] is in a range of 2 to 50 g beta-glucan per liter of aqueous solution.

6. The method according to claim 1, wherein the concentration [c2] is in a range of 10 to 150 g beta-glucan per liter of precipitate.

7. The method according to claim 1, wherein the concentration [c3] is in a range of 50 to 600 g beta-glucan per liter of precipitate.

8. The method according to claim 1, wherein said beta-glucan is selected from the group consisting of schizophyllan, scleroglucan, cellulose, chitin, curdlan, laminarin, chrysolaminarin, lentinan, lichenin, pleuran and zymosan.

9. The method according to claim 7, wherein the at least one precipitating agent p1 is selected from the groups consisting of methyl formates, acyclic ethers, cyclic ethers, carboxylic acid esters, alcohols, ketones, polyethylene glycols having molecular weights of 10 to 200 kD, polypropylene glycols having molecular weights in the range of 5 to 100 kD, and any one mixture thereof.

10. The method according to claim 1, wherein the concentrating the precipitated beta-glucan in step (b1) is performed by centrifugation, sedimentation or filtration.

11. The method according to claim 1, wherein the applying force to the concentrated precipitate beta-glucan obtained in step (b1) is an acceleration force conducted with a filter centrifuge, and the acceleration force is in a range of 50 to 2000×g.

12. The method according to claim 11, wherein steps (b1) and (c1) are simultaneously carried out in the filter centrifuge, or steps (b1) and (c1) are sequentially carried out in the filter centrifuge followed by a filter press, respectively.

13. The method according to claim 1, wherein the at least one precipitating agent p1 is added to the aqueous beta-glucan solution in step (a1) at a volume ratio of the precipating agent p1 to the aqueous solution is in a range of 1 to 10 to 20:1.

14. The method according to claim 1, further comprising the steps of:
(a2) contacting the concentrated precipitate beta-glucan obtained in step (b1) with at least one precipitating agent p2, and further concentrating the precipitated beta-glucan to obtain a concentrated precipitate beta-glucan having a concentration [c22];
(c1) applying force to the concentrated precipitate beta-glucan with p1 and p2 precipitating agents to obtain a precipitated beta-glucan having a concentration [c3] of 50 to 800 g beta-glucan per liter of,
whereby the order of the concentrations is [c1]<[c22]<[c3].

15. A precipitated beta-glucan obtained according to claim 1.

16. The precipitated beta-glucan of claim 15 having a concentration [c3] in the range of 50 to 800 g beta-glucan per liter of precipitate.

17. The method according to claim 6, wherein the concentration [c3] is in a range of 50 to 600 g beta-glucan per liter of precipitate.

18. The method according to claim 1, wherein the applying force to the concentrated precipitate beta-glucan obtained in step (b1) is conducted in a filter press at a pressure in a range of 3 bar to 25 bar.

19. A method for concentrating a beta-glucan comprising the steps of:
(a1) mixing an aqueous beta-glucan solution having a concentration [c1] of at least 2 g beta-glucan per liter of aqueous solution with at least one precipitating agent p1 to obtain a precipitated beta-glucan in an aqueous solvent mixture,
wherein the beta-glucan is selected from the group consisting of schizophyllan, scleroglucan, cellulose, chitin, curdlan, laminarin, chrysolaminarin, lentinan, lichenin, pleuran and zymosan, and the at least one precipitating agent p1 is selected from the groups consisting of methyl formates, acyclic ethers, cyclic ethers, carboxylic acid esters, alcohols, ketones, polyethylene glycols having molecular weights of 10 to 200 kD, polypropylene glycols having molecular weights in the range of 5 to 100 kD, and any one mixture thereof;
(b1) concentrating by partial separation of the precipitated beta-glucan from the aqueous solvent mixture obtained in step (a1) to obtain a concentrated precipitate beta-glucan having a concentration [c2];
(c1) applying force to the concentrated precipitate beta-glucan obtained in step (b1) to obtain a precipitated beta-glucan having a concentration [c3] of 50 to 800 g beta-glucan per liter of (c1) precipitate, the (c1) precipitate comprising the beta-glucan, the water and the at least one precipating agent p1,
wherein the concentrations is [c1]<[c2]<[c3], and the concentration [c1] is in a range of 2 to 50 g beta-glucan per liter of aqueous solution, the concentration [c2] is in a range of 10 to 150 g beta-glucan per liter of precipitate obtained following step (b1), and the concentration [c3] is in a range of 50 to 600 g beta-glucan per liter of the (c1) precipitate.
